(19) United States
(12) Patent Application Publication
(10) Pub. No.: US 2003/0071783 A1
(43) Pub. Date: Apr. 17, 2003

(54) Wire/wireless dual mode operating input device

(76) Inventor: Wei-Han Chen, Xin-Zhuang City (TW)

Correspondence Address: Raymond Sun, 12420 Woodhall Way, Tustin, CA, 92782, US

(21) Appl. No.: 09/978,654

(22) Filed: Oct. 16, 2001

(51) Int. Cl. G09G 5/00

(52) U.S. Cl. 345/156

(57) ABSTRACT

A computer system has a computer, a cable, an input device and a receiver. The input device has a processor, a rechargeable battery, an antenna, and a switch, with the switch coupling the antenna to the processor when the input device is operating in a wireless mode, and with the switch coupling the cable to the processor and the rechargeable battery when the input device is operating in a wired mode. The receiver is coupled to the computer and the input device, and has a processor, an antenna, and a switch. The receiver switch couples the antenna of the receiver to the processor of the receiver when the receiver is operating in a wireless mode, and the receiver switch couples the cable to the processor of the receiver when the receiver is operating in a wired mode.

### BACKGROUND OF THE INVENTION

1. Field of the Invention

The present invention relates to an input device, and in particular, to an input device that can be operated in both the wired and wireless modes.

2. Description of the Prior Art

The number of computer users have increased rapidly. In addition, the Internet is further encouraging increased use of computers through the numerous applications that are now available via the Internet.

The known peripheral input devices, such as trackballs, computer mice and joysticks, are also being made available in various communication modes. The early input devices used a cable to communicate with the computer in a wired mode, but recent input devices are using a wireless communication mode instead. As is well-known, the wireless mode allows for the omission of the cable, which is often seen as being inconvenient and cumbersome.

Although the cable is inconvenient in that it limits the movement of the input device on a desk, input devices that operate in the wired mode still use the cable to deliver power to the input device. On the other hand, wireless input devices typically use batteries for their power supply. However, batteries can present certain drawbacks to the use of wireless input devices. For example, replacement of the batteries presents an environmental pollution issue. As another example, rechargeable batteries require that the input device not be useable during the time that the battery is being recharged.

In addition, conventional recharge units that use a radio frequency receiver connected with the computer system will not recharge the batteries when the computer system is shut down. If the recharge unit is separated from the power supply unit, it will increase the cost and reduce the utility on the limited desk space.

Furthermore, interference can be a significant problem in wireless communication. In spite of efforts made by wireless communication protocols to overcome interference in radio frequency, interference can still be a problem if emitted from other wireless devices, or from the external environment. Though a wireless input device may be easy to manipulate, the occurrence of interference may still cause errors and abnormal operation in use.

Therefore, there still remains a need for an input device that avoids the drawbacks described above.

### SUMMARY OF THE DISCLOSURE

It is an object of the present invention is to provide an input device that can operate in both a wired communication mode and a wireless communication mode.

It is another object of the present invention to provide an input device that can be operated in a wireless communication mode, yet be able to receive power from a cable coupled to an external power supply.

It is yet another object of the present invention to provide an input device that can avoid the negative effects of interference.

In order to accomplish the objects of the present invention, the present invention provides a computer system having a computer, a cable, an input device and a receiver. The input device has a processor, a rechargeable battery, an antenna, and a switch, with the switch coupling the antenna to the processor when the input device is operating in a wireless mode, and with the switch coupling the cable to the processor and the rechargeable battery when the input device is operating in a wired mode. The receiver is coupled to the computer and the input device, and has a processor, an antenna, and a switch. The receiver switch couples the antenna of the receiver to the processor of the receiver when the receiver is operating in a wireless mode, and the receiver switch couples the cable to the processor of the receiver when the receiver is operating in a wired mode. The cable is a retractable cable that is secured to either the receiver or the input device.

### BRIEF DESCRIPTION OF THE DRAWINGS

FIG. 1 is a perspective view of a system according to one embodiment of the present invention.

FIG. 2 is a side sectional view of the receiver of the system of FIG. 1.

FIG. 3 is a circuit block diagram illustrating some of the components of the receiver of FIG. 2.

FIG. 4 is a circuit block diagram illustrating some of the components of the input device of the system of FIG. 1.

FIG. 5 is a perspective view of a system according to another embodiment of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

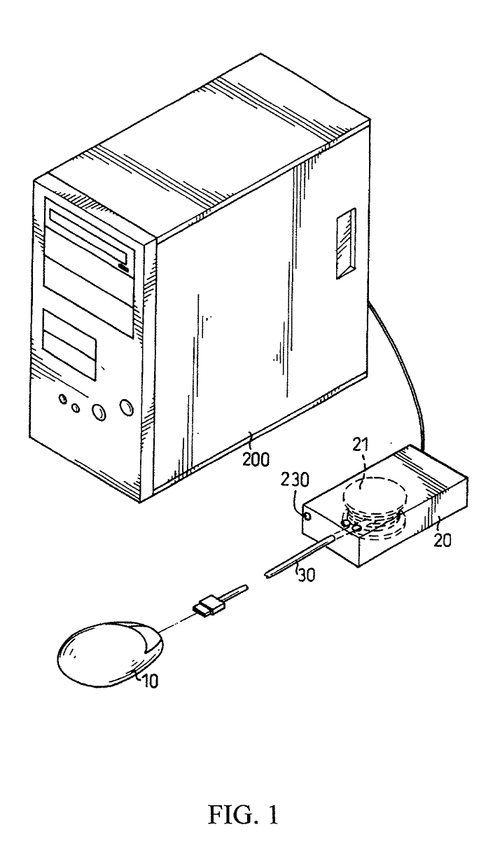

Referring to FIG. 1, a preferred embodiment according to the present invention includes at least one input device 10, a receiver 20 that is connected with a computer 200 and which receives signals transmitted from the input device 10, and a signal/power cable 30 connected between the receiver 20 and the input device 10. The cable 30 is adapted for use in the wired communication mode, and can be a retractable cable that is wound automatically. According to this embodiment, one input device 10 corresponds to one receiver 20.

The connection between the receiver 20 and the computer 200 is illustrated herein as being a wired connection, although it is also possible to provide the connection between the receiver 20 and the computer 200 to be a wireless connection.

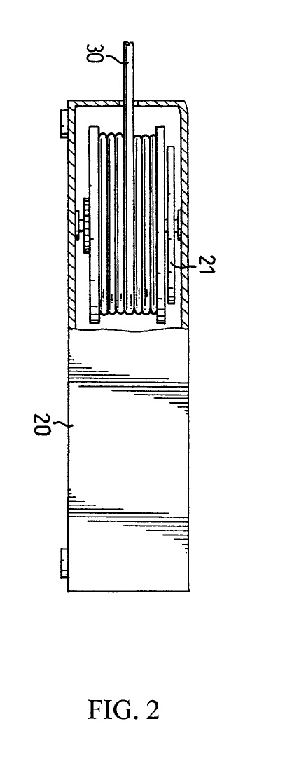

Referring now to FIG. 2, the receiver 20 has an auto-winding device 21 which has a reel (not shown) for winding the cable 30, and a positioning mechanism (not shown) for positioning the cable 30 in a desired length while pulling out the reel. The auto-winding device 21 is similar to a known ratchet structure, and shall not be described in greater detail herein. Although the auto-winding device 21 is shown as being positioned in the receiver 20, it is also possible to reverse the arrangement so as to position the auto-winding device 21 within the input device 10.

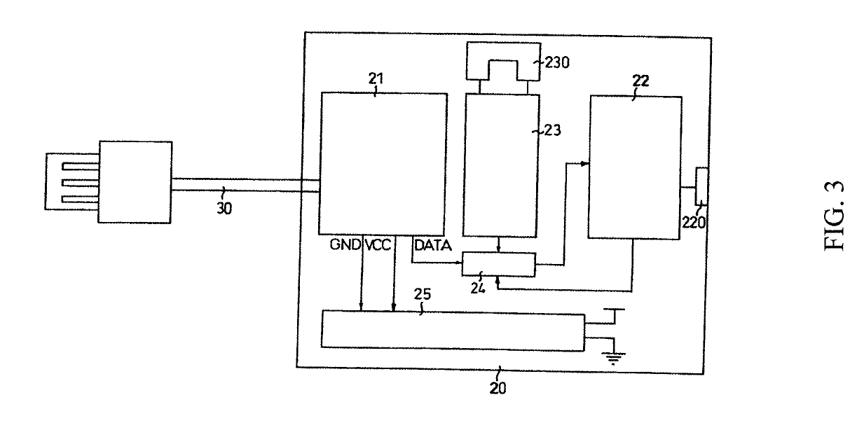

FIG. 3 ilustrates other components of the receiver 20, which includes a microprocessor 22, an RF receiving unit 23, an auto switch 24, and a power circuit 25. The microprocessor 22 receives and encodes signals transmitted from the input device 10, and then forwards the signals to the computer 200 through an interface port 220. The RF receiving unit 23 has an antenna 230 at one end for receiving signals transmitted wirelessly from the input device 10. The auto-switch 24 has an output end and three input ends, with the output end connected to the microprocessor 22, a first of the three input ends connected with the RF receiving unit 23, a second of the three input ends connected with auto-winding device 21 for receiving signals transmitted from the signal/power cable 30 during wired communication, and a third input end connected to the microprocessor 22. The microprocessor 22 will control the auto-switch 24 to receive the signals from either the signal/power cable 30 during wired communication, or from the RF receiving unit 23 during wireless communication. The power circuit 25 is coupled to the auto-winding device 21 for supplying electricity to the input device 10 via the signal/power cable 30.

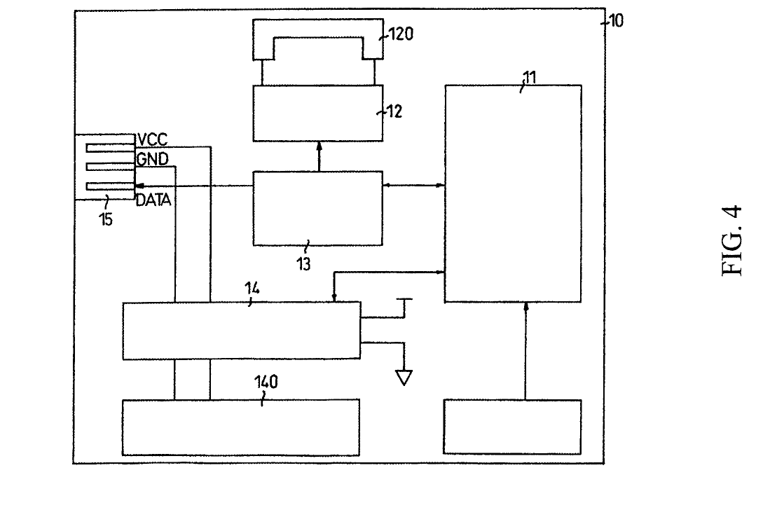

Referring now to FIG. 4, the input device 10 has a microprocessor 11, an RF output unit 12, an auto-switch 13, and a power circuit 14. The microprocessor 11 receives input signals from a user. The RF output unit 12 has an antenna 120 which outputs signals from the microprocessor 11. The auto-switch 13 has an input end connected with the microprocessor 11, and two output ends connected with the RF output unit 12 and the signal/power cable 30 (via a wire connecting port 15). The power circuit 14 is connected to a rechargeable battery 140 for supplying electricity to the input device 10 when the input device 10 is operating in the wireless communication mode. The power circuit 14 also receives power from the computer 200 (via the signal/power cable 30, the receiver 20, and the wire connecting port 15) to recharge the rechargeable battery 140 when the input device 10 is in the wired communication mode. The wire connecting port 15 connects the input device 10 with the signal/power cable 30, and functions to forward signals to the auto-switch 13, and to transmit power to the power circuit 14.

When the wire connecting port 15 is not connected with the signal/power cable 30, the input device 10 will work in the wireless communication mode, with the auto-switch 13 connecting the microprocessor 11 to the RF output unit 12 so as to output signals via antenna 120 in wireless form. Since the signal/power cable 30 is not connected to the receiver 20, the RF receiving unit 23 of the receiver 20 will receive (via antenna 230) signals that have been output from the input device 10, and then the auto-switch 24 connects the microprocessor 22 to the RF receiving unit 23 for forwarding these signals to the computer 200 via the interface port 220.

In addition, when the electricity of the rechargeable battery 140 is exhausted, or if the interference in radio frequency is serious, the user can pull out (i.e., unwind) the retractable signal/power cable 30 in a desired length from the receiver 20 to connect the cable 30 with the input device 10. At this time, the input device 10 and the receiver 20 will be switched to operate in a wired communication mode. In the input device 10, the microprocessor 11 will output signals via the auto-switch 13 to the signal/power cable 30, while simultaneously, the rechargeable battery 140 connected with the power circuit 14 will be recharged via the signal/power cable 30. In the mean time, in the receiver 20, the signal/power cable 30 will forward signals from the input device 10 to the auto-switch 24 and then on to the microprocessor 22, which will send these signals to the computer 200 via the interface port 220.

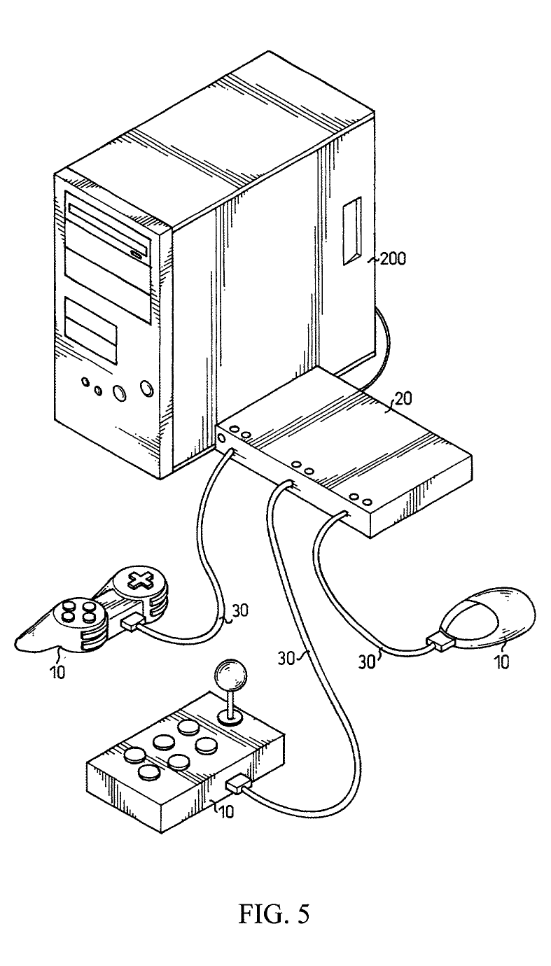

FIG. 5 illustrates an alternative embodiment of the present invention, where the receiver 20 can be coupled to a plurality of input devices 10. In addition, separate auto-winding devices 21 can be located within the input devices 10, or within the receiver 20 individually. As shown in FIG. 5, the input device 10 can be a computer mouse, a track ball, a tablet, a joystick, a game pad, or a keyboard.

Although the system described in the present invention uses radio frequency (RF) for wireless communication, other forms of wireless communication can also be utilized, such as infrared (IR) wireless communication.

Thus, as set forth above, the present invention has several advantages:

Dual mode operation: when the power of the input device 10 is exhausted when operating in the wireless communication mode, the input device 10 still can receive power from the computer system via a cable 30. Similarly, when the interference is too disruptive for use in the wireless communication mode, the input device 10 still can input signals to the computer system via the cable 30. In any case, the user is able to select a preferred mode in which to operate the input device 10 at an optimal basis.

Friendly to the environment: by using a rechargeable battery, waste disposal and pollution can be avoided.

Cost saving: the input device 10 is essentially a wireless device and therefore does not need an extra recharging unit.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A computer system, comprising:
a computer;
a cable;
an input device having a processor, a rechargeable battery, an antenna, and a switch, wherein the switch couples the antenna to the processor when the input device is operating in a wireless mode, and the switch couples the cable to the processor and the rechargeable battery when the input device is operating in a wired mode; and
a receiver coupled to the computer and the input device, the receiver having a processor, an antenna, and a switch, wherein the receiver switch couples the antenna of the receiver to the processor of the receiver when the receiver is operating in a wireless mode, and the receiver switch couples the cable to the processor of the receiver when the receiver is operating in a wired mode;
wherein the cable is a retractable cable that is secured to either the receiver or the input device.

2. The system of claim 1, wherein the cable is secured to the receiver and is removably coupled to the input device.

3. The system of claim 1, wherein the input device further includes a signal output unit that is coupled to the switch of the input device and the antenna of the input device for outputting signals from the processor of the input device when in the wireless communication mode.

4. The system of claim 1, wherein the input device further includes a power circuit coupled to the rechargeable battery and the cable.

5. The system of claim 1, wherein the receiver further includes a receiving unit that is coupled to the switch of the receiver and the antenna of the receiver for receiving signals from the input device when in the wireless communication mode.

6. The system of claim 1, wherein the receiver further includes a power circuit coupled to the cable.

7. The system of claim 1, wherein the input device further includes a wire connecting port that is coupled to the switch of the input device and the cable.

8. The system of claim 1, wherein the receiver further includes an auto-winding device that is secured to the cable.

9. The system of claim 2, wherein the input device is selected from the group consisting of a computer mouse, a trackball, a game controller and a keyboard.

10. An input device assembly, comprising:
a cable;
an input device having a processor, a rechargeable battery, an antenna, and means for coupling the antenna to the processor when the input device is operating in a wireless communication mode, and for coupling the cable to the processor when the input device is operating in a wired communication mode; and
a receiver having a processor, an antenna, and means for coupling the antenna of the receiver to the processor of the receiver when the receiver is operating in a wireless communication mode with the input device, and for coupling the cable to the processor of the receiver when the receiver is operating in a wired communication mode with the input device;
wherein the cable is a retractable cable that is secured to either the receiver or the input device.

11. The assembly of claim 10, wherein the cable is secured to the receiver and is removably coupled to the input device.

12. The assembly of claim 10, wherein the input device further includes a signal output unit that is coupled to the switch of the input device and the antenna of the input device for outputting signals from the processor of the input device when in the wireless communication mode.

13. The assembly of claim 10, wherein the input device further includes a power circuit coupled to the rechargeable battery and the cable.

14. The assembly of claim 10, wherein the receiver further includes a receiving unit that is coupled to the switch of the receiver and the antenna of the receiver for receiving signals from the input device when in the wireless communication mode.

15. The assembly of claim 10, wherein the receiver further includes a power circuit coupled to the cable.

16. The assembly of claim 10, wherein the input device further includes a wire connecting port that is coupled to the switch of the input device and the cable.

17. The assembly of claim 11, wherein the receiver further includes an auto-winding device that is secured to the cable.

18. The assembly of claim 10, wyherein the input device is selected from the group consisting of a computer mouse, a trackball, a game controller and a keyboard.

19. A method of effecting communication between an input device and a computer, comprising:
coupling a receiver to a computer;
providing the receiver with a wireless receiving element and a cable port;
providing the input device with a wireless transmitting element and a cable port;
establishing wireless communication between the wireless transmitting element and the wireless receiving element;
extending a retractable cable from either the receiver or the input device to be releasably coupled to the other of the receiver or the input device; and
switching the communication to a wired communication between the cable ports of the receiver and the input device.
